(19) United States
(12) Patent Application Publication
(10) Pub. No.: US 2026/0086678 A1
(43) Pub. Date: Mar. 26, 2026

(54) Display to Touch Interference Compensation Systems and Methods

(71) Applicant: Apple Inc., Cupertino, CA (US)

(72) Inventors: Michael R. White, San Jose, CA (US); Schuyler A. Tilney-Volk, San Francisco, CA (US); Sanjay Mani, Los Altos Hills, CA (US); Ahmed Mokhtar Nagy Ibrahim, Corona, CA (US); Aryan Hazeghi, San Jose, CA (US); Meir Harar, Tel-Aviv (IL); Alexander M. Mrozack, Mountain View, CA (US); Mahesh B. Chappalli, San Jose, CA (US)

(21) Appl. No.: 19/337,622

(22) Filed: Sep. 23, 2025

Related U.S. Application Data
(60) Provisional application No. 63/699,691, filed on Sep. 26, 2024.

(51) Int. Cl. G06F 3/041

(52) U.S. Cl. CPC G06F 3/0418; G06F 3/04166

(57) ABSTRACT

Systems, methods, and devices are described that may mitigate pixel and touch crosstalk noise. A touch processing system may adjust touch scan data to reduce the noise based on an estimated amount of impedance display-to-touch interference (impedance DTI). Using the adjusted touch scan data, the touch processing system may determine a proximity of a capacitive object to at least one touch sense region of the electronic display with improved signal to noise ratio.

This application claims priority to U.S. Provisional Application No. 63/699,691, filed Sep. 26, 2024, which is incorporated by reference herein in its entirety for all purposes.

### SUMMARY

This disclosure relates to mitigating crosstalk between display and touch subsystems and, more specifically, to mitigating undesired interference between the subsystems.

A summary of certain embodiments disclosed herein is set forth below. It should be understood that these aspects are presented to provide the reader with a brief summary of these certain embodiments and that these aspects are not intended to limit the scope of this disclosure.

Electronic displays may be found in numerous electronic devices, from mobile phones to computers, televisions, automobile dashboards, and augmented reality or virtual reality glasses, to name just a few. Electronic displays with self-emissive display pixels produce their own light. Self-emissive display pixels may include any suitable light-emissive elements, including light-emitting diodes (LEDs) such as organic light-emitting diodes (OLEDs) or micro-light-emitting diodes (μLEDs). By causing different display pixels to emit different amounts of light, individual display pixels of an electronic display may collectively produce images.

An electronic display may include both a display subsystem and a touch subsystem, such as in an integrated panel or system-on-a-chip (SOC). However, these subsystems may experience crosstalk during operation, such as when touch sensing occurs while image presentation is ongoing. Examples of the crosstalk include impedance-based display-touch interference (impedance DTI).

With impedance DTI, image data presented by the display may cause image data-dependent changes in a nuisance impedance, which may be present when generating touch scan data. Impedance DTI may result in a touch baseline shift where the touch scan data gets modulated by display image content changing cathode impedance. Thus, it may be desirable to compensate for any crosstalk, like impedance DTI, occurring between the display and touch subsystems.

To compensate for impedance DTI, a touch sensing system may determine a display stack impedance during a touch scan. The display stack impedance may be content and/or brightness dependent and spatially varying. An image process system may calculate the display impedance directly for a display frame or any other metric that can estimate content-dependent total display impedance. The image processing system may transmit complex pixel or “tiled” impedance values, display image pixel current, or “tiled” display current values using any symmetric or asymmetric spatial tile definition. The touch processing system may use the values to either directly calculate display impedance or calculate interference directly using a linear model or non-linear model. The touch processing system may use the statistics to estimate, directly cancel, or feed into an algorithm the undesired impedance DTI component of the touch sensing signal.

### BRIEF DESCRIPTION OF THE DRAWINGS

Various aspects of this disclosure may be better understood upon reading the following detailed description and upon reference to the drawings described below.

FIG. 1 is a schematic block diagram of an electronic device, in accordance with an embodiment;

FIG. 2 is a front view of a mobile phone representing an example of the electronic device of FIG. 1, in accordance with an embodiment;

FIG. 3 is a front view of a tablet device representing an example of the electronic device of FIG. 1, in accordance with an embodiment;

FIG. 4 is a front view of a notebook computer representing an example of the electronic device of FIG. 1, in accordance with an embodiment;

FIG. 5 are front and side views of a watch representing an example of the electronic device of FIG. 1, in accordance with an embodiment;

FIG. 6 is another example of the electronic device of FIG. 1 in the form of a computer, in accordance with an embodiment;

FIG. 7 is a block diagram of a display pixel array of the electronic display of FIG. 1, in accordance with an embodiment;

FIG. 8 is a block diagram of a touch sensor array of the electronic display of FIG. 1, in accordance with an embodiment;

FIG. 9 is a diagrammatic representation of a portion of an electronic display of FIG. 1 that includes the display pixel array of FIG. 6 and the touch sensor array of FIG. 7, in accordance with an embodiment;

FIG. 10 is a block diagram of a portion of the electronic device of FIG. 1 including a touch processing subsystem operational based on a physics engine and a display subsystem corresponding to the electronic display of FIG. 8, in accordance with an embodiment;

FIG. 11 is a block diagram of the physics engine of FIG. 10, in accordance with an embodiment;

FIG. 12 is a diagrammatic representation of an example portion of the impedance DTI model of FIG. 10, in accordance with an embodiment;

FIG. 13 is a diagrammatic representation of a cathode resistor capacitor network associated with the model of FIG. 12 and the physics engine of FIG. 10 and/or FIG. 11 to determine the expected cathode voltage of FIG. 12, in accordance with an embodiment; and

FIG. 14 is a diagrammatic representation of a process for applying an example of asymmetric spatial tile definition (e.g., an interleaved tile definition) to the physics engine of FIG. 11, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “including” and “having” are intended to be inclusive and mean that there may be additional elements other than the listed elements. Additionally, it should be understood that references to “some embodiments,” “embodiments,” “one embodiment,” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

The present disclosure provides systems and methods for integrating a touch panel and a display panel into a single panel, which may reduce material costs and lower component footprints within an electronic display or device. For devices with integrated display and touch subsystems, special care may be taken to avoid crosstalk and noise between the subsystems. Examples of the crosstalk include impedance-based display-touch interference (impedance DTI), which may introduce undesired noise in touch sensing operations, increasing an inaccuracy of such operations.

Inaccurate touch sensing operations may lead to lagged response of the electronic device to the tactile input (e.g., from a user's touch, from an object like a pencil or stylus device), performance of incorrect operations in response to the tactile input, undesirable results to occur in response to the tactile input, or the like. When undesired operations are performed in response to tactile inputs, computing resources may be spent performing the undesired operations, ending the undesired operations, or correcting the undesired operations in response to further received tactile input. Thus, it may be desirable to compensate for the impedance DTI in touch image data captured before the tactile input is determined from the touch scan data to improve accuracy of touch sensing operations. Improving accuracy of touch sensing operations may lead to improved user experience with the electronic device and/or improved electronic device performance through reducing a likelihood of inefficient allocation of computing resources.

Keeping the foregoing in mind, described herein are systems and methods that may mitigate effects of the impedance DTI to improve user experience and device performance. Indeed, the systems and methods may use image-independent parameters (e.g., image-independent data) and image-dependent parameters (e.g., image-dependent data), like anode voltage data, data line voltage data, and/or pixel emission current data, to determine an estimate of the impedance DTI. The estimated impedance DTI may be sent as an input to noise removal operations. The estimated impedance DTI may be used as a baseline of an expected amount of noise from which the noise removal operations can better remove actual noise in touch scan data. By removing the actual noise from the touch scan data based on expected noise, the systems and methods may compensate for the crosstalk from impedance DTI.

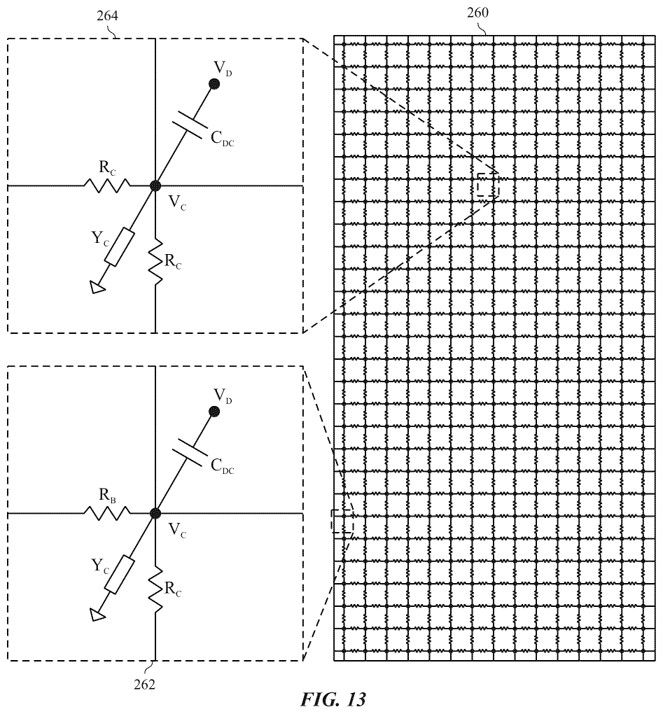

To compensate for impedance DTI, a touch sensing system may determine display stack impedance during a touch scan. The cathode impedance may be spatially varying and content dependent and/or brightness dependent. An image processing system may calculate the display impedance directly for a display frame or any other metric that may estimate content-dependent total display impedance. The image processing system may transmit complex pixel or “tiled” impedance values, display image pixel current, or “tiled” display current values using any suitable symmetric or asymmetric spatial tile definition (e.g., interleaved tile definition of FIG. 13). The touch processing system may use the statistics to either directly calculate display impedance or calculate interference directly using a linear model or a non-linear model. The touch processing system may use the statistics to estimate, directly cancel, or feed into an algorithm the undesired impedance DTI component of the touch sensing signal.

Compensating for impedance DTI may improve device operation. For example, an electronic device compensating for the crosstalk may improve performance of the touch processing subsystem and/or may reduce an amount of power consumed by the touch processing subsystem by mitigating interference associated with the crosstalk.

These described systems and methods may be used by any device with relatively tight integration of display and touch subsystems, such as displays with in-cell or on-cell touch. Furthermore, these described systems and methods may differ from other crosstalk compensation systems in that those described herein may not use display current aggregation methods when compensating for impedance DTI. As described herein, data corresponding to one or more, or each, display pixels may be processed based on a linear model, a non-linear model, a look-up table storing a relationship to determine individual impedance corresponding to each of the one or more display pixels, or the like. Once the various individual impedances are determined, the system may determine a total impedance indication based on the aggregate of each of the individual impedances performed in an impedance domain. Average Pixel Luminance (APL) maps may or may not be used in the systems and methods described herein, where in some systems a tile may correspond to a relatively smaller APL map, such as an APL map corresponding to a portion of the display panel less than an entire display panel. Indeed, impedance DTI estimates as described herein may be used to “seed” processing operations, like noise-to-signal separation operations, or operate as a baseline or an initial guess, from which to perform relatively higher accuracy impedance DTI determination and compensation operations. Due to the size of certain larger panels, lumped circuit modeling may be an inefficient use of computing resources due to the total number of values used to represent an entire large display panel. Indeed, alternative methods are described herein that may enable converting display current values to impedances using a calibrated look-up table or other globally tuned model, mapping to display impedances, and/or adding in a touch current domain. Systems and methods described herein may use touch sensing methods based on a continuous time of a narrowband sine wave stimulus, which (relative to smaller panels that may use discrete samplings of a square wave) help improve performance by eliminating or making settling charges have a negligible effect. Furthermore, systems and methods described herein may be based on one or more mutual capacitance models, as opposed to self-capacitance sensing models, leading to a different use of some capacitance values when determining the impedance DTI.

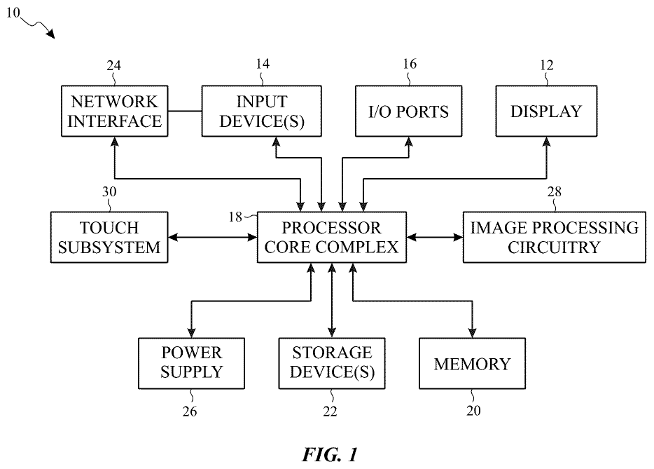

Overall, systems and methods described herein may apply lessons learned from Watch and smaller panel devices to larger panel devices and devices able to be used in conjunction with a multi-tone stimulus in a way that is cost and computing resource efficient. Other systems, however, may also benefit from using these systems and methods (e.g., non-integrated but spatially nearby display and touch subsystems). With this in mind, an example of an electronic device 10, which includes an electronic display 12 that may benefit from these features, is shown in FIG. 1.

To help illustrate, an example of an electronic device 10, which includes and/or utilizes an electronic display 12, is shown in FIG. 1. As will be described in more detail below, the electronic device 10 may be any suitable electronic device, such as a computer, a mobile (e.g., portable) phone, a portable media device, a tablet device, a television, a handheld game platform, a personal data organizer, a virtual-reality headset, a mixed-reality headset, a vehicle dashboard, and/or the like. Thus, it should be noted that FIG. 1 is merely one example of a particular implementation and is intended to illustrate the types of components that may be present in an electronic device 10.

In addition to the electronic display 12, as depicted, the electronic device 10 includes one or more input devices 14, one or more input/output (I/O) ports 16, a processor core complex 18 having one or more processors or processor cores, main memory 20, one or more storage devices 22, a network interface 24, a power supply 26, image processing circuitry 28, and a touch subsystem 30. The various components described in FIG. 1 may include hardware elements (e.g., circuitry), software elements (e.g., a tangible, non-transitory computer-readable medium storing instructions), or a combination of both hardware and software elements. It should be noted that the various depicted components may be combined into fewer components or separated into additional components. For example, the main memory 20 and a storage device 22 may be included in a single component. In another example, the image processing circuitry 28 may be included in the processor core complex 18 or the electronic display 12. As described herein, the image processing circuitry 28 may be part of a display subsystem that may be integrated with the touch subsystem 30 and within the electronic display 12 or on a system-on-a-chip (SOC) separate from the electronic display 12.

As depicted, the processor core complex 18 is operably coupled with main memory 20 and the storage device 22. As such, in some embodiments, the processor core complex 18 may execute instructions stored in main memory 20 and/or a storage device 22 to perform operations, such as generating image data. Additionally or alternatively, the processor core complex 18 may operate based on circuit connections formed therein. As such, in some embodiments, the processor core complex 18 may include one or more general purpose microprocessors, one or more application specific processors (ASICs), one or more field programmable logic arrays (FPGAs), or any combination thereof.

In addition to instructions, in some embodiments, the main memory 20 and/or the storage device 22 may store data, such as image data. Thus, in some embodiments, the main memory 20 and/or the storage device 22 may include one or more tangible, non-transitory, computer-readable media that store instructions executable by processing circuitry, such as the processor core complex 18 and/or the image processing circuitry 28, and/or data to be processed by the processing circuitry. For example, the main memory 20 may include random access memory (RAM) and the storage device 22 may include read only memory (ROM), rewritable non-volatile memory, such as flash memory, hard drives, optical discs, and/or the like.

As depicted, the processor core complex 18 is also operably coupled with the network interface 24. In some embodiments, the network interface 24 may enable the electronic device 10 to communicate with a communication network and/or another electronic device 10. For example, the network interface 24 may connect the electronic device 10 to a personal area network (PAN), such as a Bluetooth network, a local area network (LAN), such as an 802.11x Wi-Fi network, and/or a wide area network (WAN), such as a 4G or LTE cellular network. In other words, in some embodiments, the network interface 24 may enable the electronic device 10 to transmit data (e.g., image data) to a communication network and/or receive data from the communication network.

Additionally, as depicted, the processor core complex 18 is operably coupled to the power supply 26. In some embodiments, the power supply 26 may provide electrical power to operate the processor core complex 18 and/or other components in the electronic device 10, for example, via one or more power supply rails. Thus, the power supply 26 may include any suitable source of electrical power, such as a rechargeable lithium polymer (Li-poly) battery and/or an alternating current (AC) power converter.

Furthermore, as depicted, the processor core complex 18 is operably coupled with one or more I/O ports 16. In some embodiments, the I/O ports 16 may enable the electronic device 10 to interface with another electronic device 10. For example, a portable storage device may be connected to an I/O port 16, thereby enabling the electronic device 10 to communicate data, such as image data, with the portable storage device.

As depicted, the processor core complex 18 is also operably coupled with one or more input devices 14. In some embodiments, an input device 14 may enable a user to interact with the electronic device 10. For example, the input devices 14 may include one or more buttons, one or more keyboards, one or more mice, one or more trackpads, and/or the like. Additionally, in some embodiments, the input devices 14 may include touch sensing components implemented in the electronic display 12. In certain instances, the touch subsystem 30 may include the touch sensing components implemented in the electronic display 12 to receive user inputs by detecting occurrence and/or position of an object contacting the display surface of the electronic display 12.

In certain instances, the image processing circuitry 28 may be implemented within the processor core complex 18 and perform functions such as adjusting image data for display on the electronic display 12. In addition to enabling user inputs, the electronic display 12 may facilitate providing visual representations of information by displaying one or more images (e.g., image frames or pictures). For example, the electronic display 12 may display a graphical user interface (GUI) of an operating system, an application interface, text, a still image, or video content. To facilitate displaying images, as will be described in more detail below, the electronic display 12 may include a display panel with one or more display pixels.

As described above, an electronic display 12 may display an image by controlling luminance of its display pixels based at least in part on image data associated with corresponding image pixels (e.g., points) in the image. In some embodiments, image data may be generated by an image source, such as the processor core complex 18, a graphics processing unit (GPU), and/or an image sensor. Additionally, in some embodiments, image data may be received from another electronic device 10, for example, via the network interface 24 and/or an I/O port 16. In any case, as described above, the electronic device 10 may be any suitable electronic device.

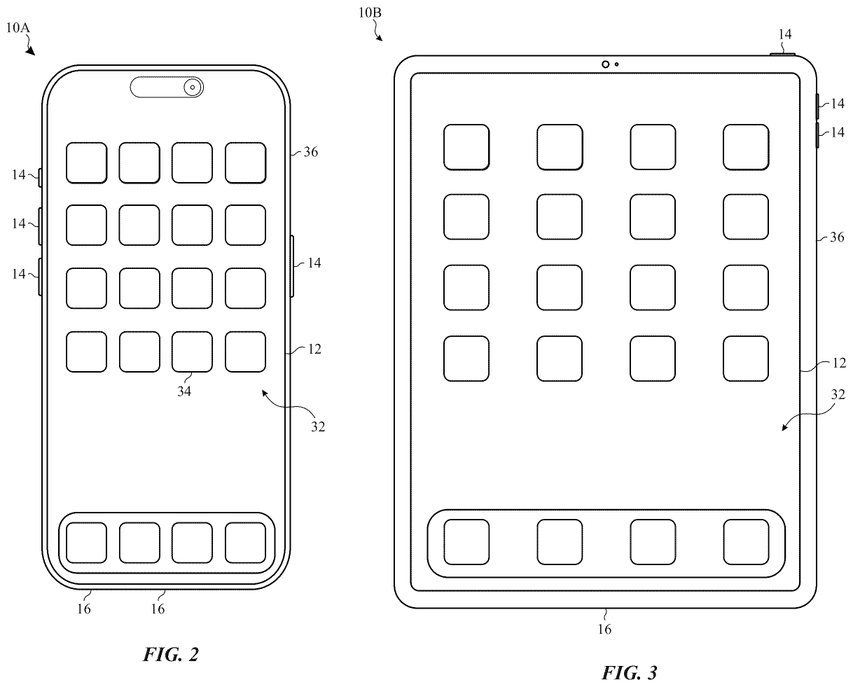

To help illustrate, one example of a suitable electronic device 10, specifically a handheld device 10A, is shown in FIG. 2. In some embodiments, the handheld device 10A may be a portable phone, a media player, a personal data organizer, a handheld game platform, and/or the like. For example, the handheld device 10A may be a smart phone, such as any iPhone® model available from Apple Inc.

As depicted, the handheld device 10A includes an enclosure 36 (e.g., housing). In some embodiments, the enclosure 36 may protect interior components from physical damage and/or shield them from electromagnetic interference. Additionally, as depicted, the enclosure 36 surrounds the electronic display 12. In the depicted embodiment, the electronic display 12 is displaying a graphical user interface (GUI) 32 having an array of icons 34. By way of example, when an icon 34 is selected either by an input device 14 or by a component of the touch subsystem 30 of the electronic display 12, an application program may be launched.

Furthermore, as depicted, input devices 14 open through the enclosure 36. As described above, the input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, and/or toggle between vibrate and ring modes. As depicted, the I/O ports 16 also open through the enclosure 36. In some embodiments, the I/O ports 16 may include, for example, an audio jack to connect to external devices.

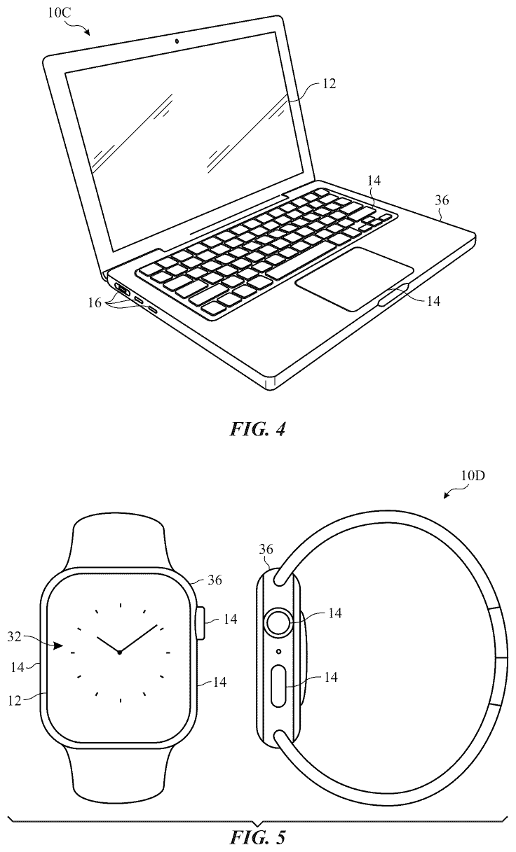

To help further illustrate, another example of a suitable electronic device 10, specifically a tablet device 10B, is shown in FIG. 3. For illustrative purposes, the tablet device 10B may be any iPad® model available from Apple Inc. A further example of a suitable electronic device 10, specifically a computer 10C, is shown in FIG. 4. For illustrative purposes, the computer 10C may be any Macbook® or iMac® model available from Apple Inc. Another example of a suitable electronic device 10, specifically a watch 10D, is shown in FIG. 5. For illustrative purposes, the watch 10D may be an Apple Watch® model available from Apple Inc. As depicted, the tablet device 10B, the computer 10C, and the watch 10D each also includes an electronic display 12, input devices 14, I/O ports 16, and an enclosure 36. In any case, as described above, an electronic display 12 may generally display images based at least in part on image data, for example, output from the processor core complex 18 and/or the image processing circuitry 28.

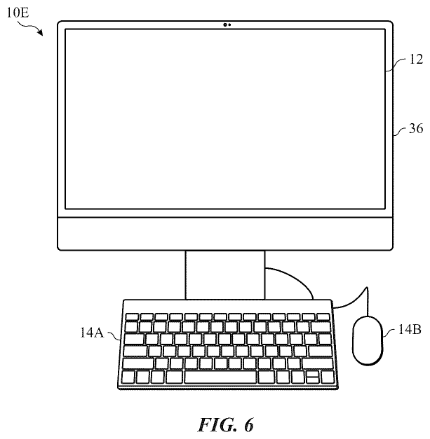

Turning to FIG. 6, a computer 10E may represent another embodiment of the electronic device 10 of FIG. 1. The computer 10E may be any suitable computer, such as a desktop computer or a server, but may also be a standalone media player or video gaming machine. By way of example, the computer 10E may be an iMac® or other device by Apple Inc. of Cupertino, California. It should be noted that the computer 10E may also represent a personal computer (PC) by another manufacturer. A similar enclosure 36 may be provided to protect and enclose internal components of the computer 10E, such as the electronic display 12. In certain embodiments, a user of the computer 10E may interact with the computer 10E using various peripheral input devices 14, such as a keyboard 14A or mouse 14B, which may connect to the computer 10E.

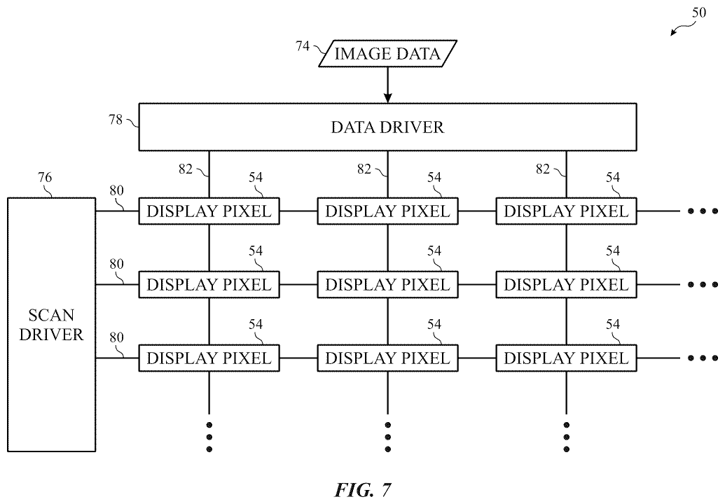

Keeping the foregoing in mind, FIG. 7 is a block diagram of a display pixel array 50 (e.g., display subsystem) of the electronic display 12. It should be understood that, in an actual implementation, additional or fewer components may be included in the display pixel array 50.

The electronic display 12 may receive image data 74 for presentation on the electronic display 12. The electronic display 12 includes display driver circuitry that includes scan driver circuitry 76 and data driver circuitry 78. The display driver circuitry controls programing the image data 74 into the display pixels 54 for presentation of an image frame via light emitted according to each respective bit of image data 74 programmed into one or more of the display pixels 54.

The display pixels 54 may each include one or more self-emissive elements, such as a light-emitting diodes (LEDs) (e.g., organic light emitting diodes (OLEDs) or micro-LEDs (μLEDs)), however other pixels may be used with the systems and methods described herein including but not limited to liquid-crystal devices (LCDs), digital mirror devices (DMD), or the like, and include use of displays that use different driving methods than those described herein, including partial image frame presentation modes, variable refresh rate modes, or the like.

Different display pixels 54 may emit different colors. For example, some of the display pixels 54 may emit red (R) light, some may emit green (G) light, and some may emit blue (B) light. The display pixels 54 may be driven to emit light at different brightness levels to cause a user viewing the electronic display 12 to perceive an image formed from different colors of light. The display pixels 54 may also correspond to hue and/or luminance levels of a color to be emitted and/or to alternative color combinations, such as combinations that use cyan (C), magenta (M), or others.

The scan driver circuitry 76 may provide scan signals (e.g., pixel reset, data enable, on-bias stress) on scan lines 80 to control the display pixels 54 by row. For example, the scan driver circuitry 76 may cause a row of the display pixels 54 to become enabled to receive a portion of the image data 74 from data lines 82 from the data driver circuitry 78. In this way, an image frame of image data 74 may be programmed onto the display pixels 54 row by row. Other examples of the electronic display 12 may program the display pixels 54 in groups other than by row. In another example, the scan driver circuitry 76 may perform other operations, such as causing an anode reset voltage to be applied to an anode from time to time, causing data switching, and so on. During an anode reset, for example, the scan driver circuitry 76 may instruct a switch to close and the anode voltage (VAR) to be applied to an anode. The scan driver circuitry 76 may apply the anode reset to anodes of the electronic display 12 (which may correspond to the rows of display pixels 54) starting from a first row of the display pixels 54 proximate to a first edge of the electronic display 12 to a last row of the display pixels 54 proximate to an opposite edge of the electronic display 12. For example, the scan driver circuitry 76 may transmit an anode reset signal, which may be a rolling signal, that moves up or down the electronic display 12 in a sequential manner and causes an anode voltage to be applied to a respective anode corresponding to the row of display pixels 54. It may be understood that other display activities, such as data line switching, may use rolling signals that may be sequentially applied to each anode and/or row of the electronic display 12.

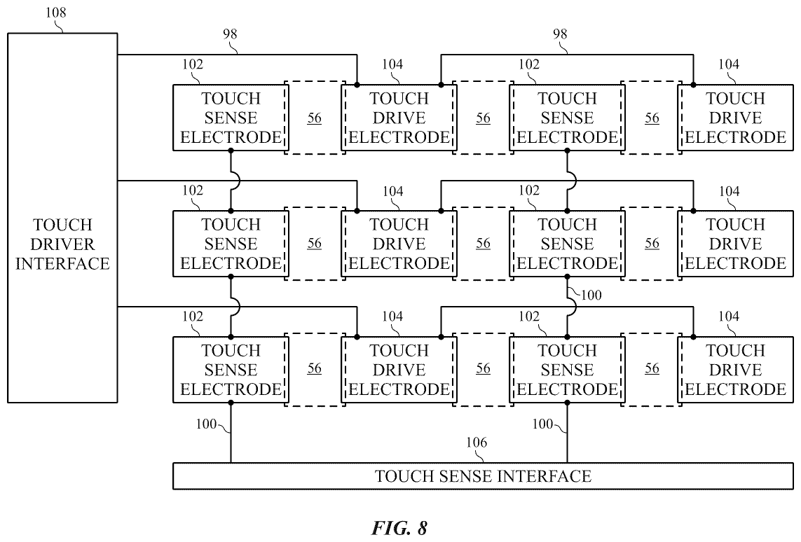

The display pixel array 50 operates differently than the touch sensor array 52 but may share some of the same electrical components with and/or may be in very close proximity to the touch sensor array 52. Referring now to operations of the touch sensor array 52, FIG. 8 is a block diagram of the touch sensor array 52 of the electronic display 12. The touch sensor array 52 may be controlled by the touch subsystem 30. Additionally or alternatively, the touch sensor array 52 and the display pixel array 50 may be integrated and disposed onto a same component, a silicon chip, a board, or the like. For example, electrodes used by the touch sensor array 52 may be formed from components (e.g., cathodes, anodes, power rails, conductive mask material) also used by the display pixel array 50.

The touch sensor array 52 includes a matrix of touch sense regions 56 formed by interactions between touch drive electrodes 104 driven via conductive lines 98 and touch sense electrodes 102 sensed via conductive lines 100. It should be noted that the terms “lines” and “electrodes” as sometimes used herein simply refer to conductive pathways, and are not intended to be limited to structures that are strictly linear. Rather, the terms “lines” and “electrodes” may encompass conductive pathways that change direction or that have different size, shape, materials, or regions. The touch sense electrodes 102 may be sensed along conductive lines 100 by a touch sense interface 106 while different rows of touch drive electrodes 104 are driven with touch drive signals along the conductive lines 98 from a touch driver interface 108. For example, the touch drive signals may be driven from a first conductive line 100 adjacent to a first edge of the electronic display 12 to a last conductive line 100 adjacent to an opposite edge of the electronic display 12 in a sequential manner over time. As referred to herein “integration time” may correspond to times during which the capacitance may be sensed by the touch sensor array 52 and/or the touch subsystem 30.

The touch sense electrodes 102 may respond differently to the touch drive signals based on a proximity of a tactile input to the touch sense electrodes 102. In this way, the presence of the object may be “seen” in a touch sense region 56 that may result at an intersection of the touch drive electrode 104 and the touch sense electrode 102. That is, the touch drive electrodes 104 and the touch sense electrodes 102 may form capacitive sensing nodes, or more aptly, the touch sense regions 56. The touch sense electrodes 102 and touch drive electrodes 104 may gather touch sense information when operating in what may be referred to herein as a touch mode of operation.

Though the touch sense electrodes 102 and the touch drive electrodes 104 may be supplied the same or substantially similar direct current (DC) bias voltage, different alternating current (AC) voltages may be supplied and/or received on touch sense electrodes 102 and touch drive electrodes 104 at substantially different times in some embodiments. For example, the electronic display 12 may switch between two modes of operation: a display mode of operation and a touch mode of operation. Furthermore, in some touch sensor arrays 52, an AC reference voltage is used as ground for the touch sensing operations associated with the touch sensor array 52.

As noted above, challenges arise when combining the display pixel array 50 and the touch sensor array 52 in an integrated touch and image panel. By nature of touch sensors (e.g., touch sense regions 56) being in relatively close proximity to the display pixels (e.g., pixels 54), sets of interference may arise between the display pixel array 50 and the touch sensor array 52.

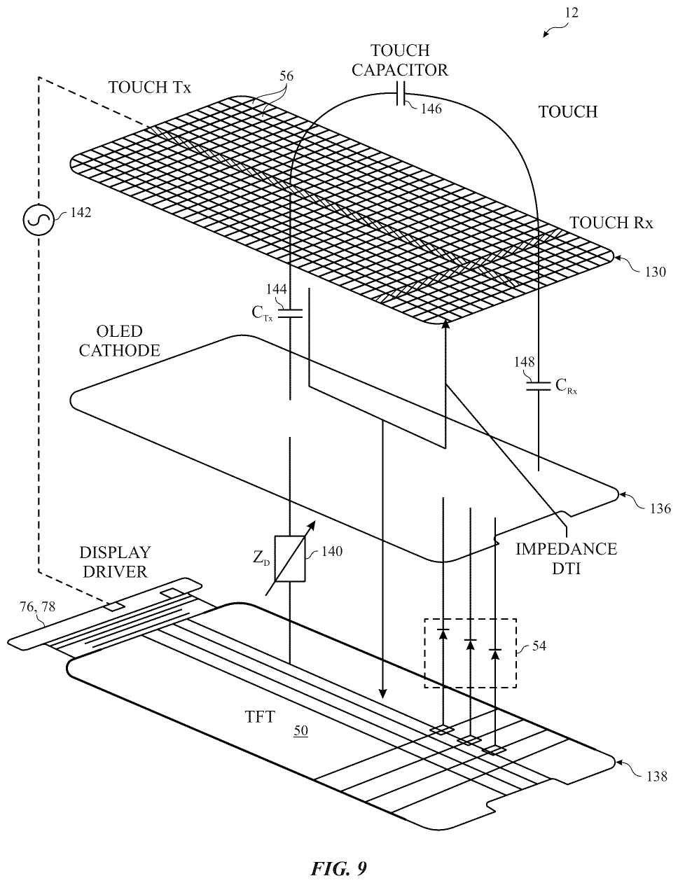

To elaborate, FIG. 9 is a diagrammatic representation of a portion of an electronic display 12 with an integrated touch and image panel. A touch layer 130 may include a touch drive electrode 104 and a touch sense electrode 102 in the same spatial plane. A cathode layer 136 may be disposed between the touch layer 130 and a display high voltage supply (ELVDD) layer 138. The cathode layer 136 may be coupled to the ELVDD layer 138 via display pixels 54. It is noted that in some display architectures, the ELVDD layer 138 may be driven to a supply volage that is a lower voltage than the cathode layer 136.

In this example, the display pixels 54 include OLED devices, however the display pixels 54 may include any suitable light-emitting device or self-emission component. Each display pixel 54 may include a capacitor coupled to a gate of a transistor (“TFT”). The transistor may be considered a current source. The capacitor may store image data for the display pixel 54. Other circuitry may be included as memory in the pixel, such as one or more back-to-back coupled inverter pairs that form a memory capable of storing multiple bits of image data.

The touch sense electrodes 102 and touch drive electrodes 104 of the touch layer 130 may be supplied the same or substantially similar direct current (DC) bias voltage, different alternating current (AC) voltages may be supplied and/or received on touch sense electrodes 102 and touch drive electrodes 104 at substantially different times in some embodiments. For example, the electronic display 12 may switch between two modes of operation: a display mode of operation and the touch mode of operation. In some touch sensor arrays 52, an AC reference voltage is used as a ground for the touch sensing operations associated with the touch sensor array 52.

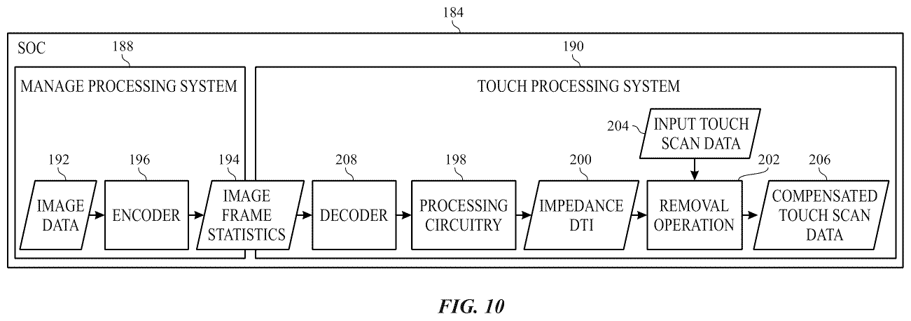

In the touch mode of operation, the display driver (e.g., scan driver circuitry 76, data driver circuitry 78) may generate a stimulus voltage from voltage generator 142 sent to the touch layer 130 while sampling of tactile inputs to the electronic display 12 occurs by the touch processing subsystem 30 (e.g., touch processing system 190 of FIG. 10). The stimulus voltage may be relatively continuously timed waveform. The stimulus voltage may be a narrowband waveform, and, in some cases, the stimulus voltage may be a sine wave or other suitable alternating current (AC) voltage. A display driver, such as the scan driver circuitry 76 or the data driver circuitry 78, generates and sends the stimulus voltage from a voltage generator 142 through a touch transmit path (Touch TX) and onto the touch system. After receiving the stimulus voltage, a touch sensor, such as the touch sense regions 56 or other suitable tactile input sensor, may generate a current in response to the stimulus voltage being received while a tactile input is received. A portion of the current may transmit from the touch sensor to a touch receive path (Touch RX), where the current may be sensed by the touch processing system and used to generate an indication of a tactile input. Meanwhile, a different portion of the current may drain from a touch sensor, such as the touch sense regions 56, to the cathode layer 136 through parasitic capacitances, such as parasitic capacitances 144, 148.

With this in mind, the amount of the current that comes back to the touch receive path may be modulated based on image content of the image frame presented via the electronic display 12 while the touch sensing operation received the tactile input. The cathode layer 136 may be electrically coupled to the ELVDD layer 138 or ground through an impedance 140. The value of the impedance 140 may be image-dependent and may change based on the image data that is currently displayed on the display pixels 54 across the display pixel array 50. Moreover, the impedances of the display itself, such as impedances of the pixels 54, change as a function of the current transmitted through the pixels 54 and therefore may also change based on the image content.

Previous image data may also affect the value of the impedance 140 (e.g., a hysteresis effect). The impedance 140 may affect values captured via a touch scan of the touch sensor array 52. For example, the impedance 140 may affect how the sine wave stimulus (e.g., stimulus voltage from voltage generator 142) propagates through the touch layer 130 and may introduce undesirable noise into touch scan data obtained during touch sensing operations.

Furthermore, parasitic capacitances (e.g., parasitic capacitance 144) may form between respective portions of the touch layer 130 and the cathode layer 136. The cathode layer 136 may be coupled via parasitic capacitance 144 (“C_{TX}”) to the touch layer 130. One portion of the touch layer 130 may be coupled via parasitic capacitance 146 to another portion of the touch layer 130. The cathode layer 136 may also be coupled via parasitic capacitance 148 (“C_{RX}”) to the touch layer 130. The parasitic capacitances 144, 146, 148 and/or the impedance 140 may contribute to Impendence DTI, which may cause sensed capacitance values to change including capacitance sensed during touch sensing operations. Thus, given the impact that image content may have on impedances of the electronic display 12, compensating for impedance DTI based on the values of image data may improve the performance of touch sensing operations in the electronic display 12.

To do so, an electronic device 10 may determine an estimated amount of impedance DTI and apply the estimated amount to remove the noise from the touch scan data. The estimated amount of impedance DTI may be determined based on statistics about an image frame to be presented, impedance statistics about the display presuming presentation of the image frame, and a relationship between those values, pre-determined calibration parameters, and the estimated amount of impedance DTI. Once impedance DTI is estimated, the electronic device 10 may remove noise from touch scan data by subtracting the estimated impedance DTI from the touch scan data. In some systems, the electronic device 10 may remove noise through “seeding” a processing operation with the estimated amount of impedance DTI, which may improve a determination of an actual amount of impedance DTI in touch scan data and make such determination more accurate. By using systems and methods described above, like the subtracting methods or “seeding” methods (e.g., seed a separation operation to identify an amount of noise to remove from the touch scan data), a signal-to-noise ratio may improve when impedance DTI is compensated for in the touch scan data.

To elaborate, FIG. 10 is a block diagram of a portion of the electronic device 10. The electronic device 10 may include a system-on-a-chip (SOC) 184 and the electronic display 12, such as the integrated image and touch display system illustrated in FIG. 9 as the electronic display 12. The SOC 184 may include an image processing system 188 and a touch processing system 190. The image processing system 188 may receive image data 192 corresponding to an image frame. The image frame may be presented via the electronic display 12 at an at least partially overlapping time to a touch scan used to detect where relative to the electronic display 12 a tactile input is received. Indeed, at least a portion of the image data corresponding to the image frame may be received as the image data 192 before the image frame is presented via the electronic display 12.

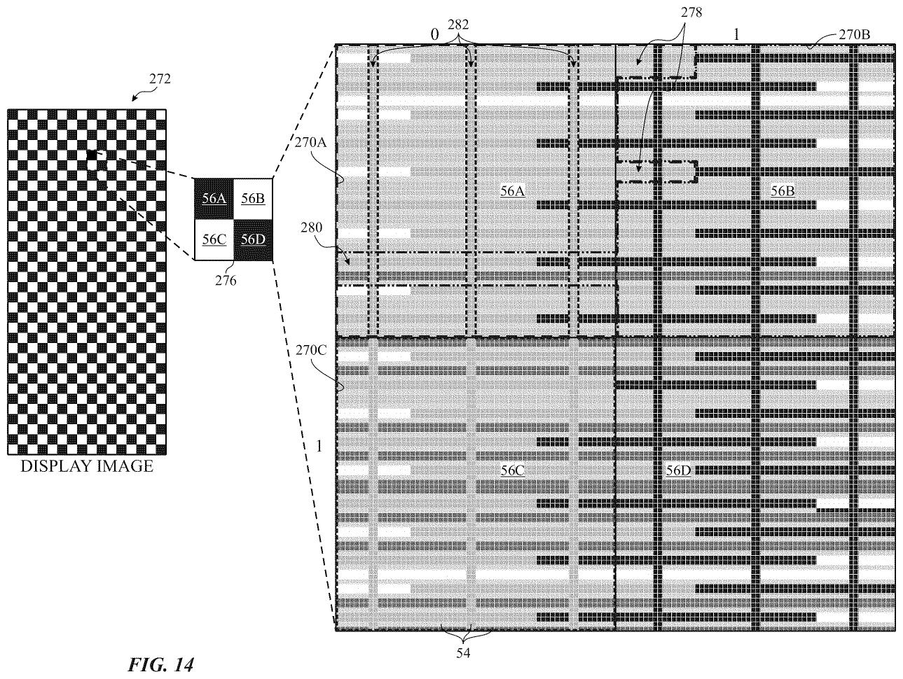

The image processing system 188, via an encoder 196, may generate the image frame statistics 194 based on the image data 192. The image frame statistics 194 may include image-dependent data. The image frame statistics 194 may indicate a predicted effect that presentation of the image data 192 is expected to have on touch scan data acquired in the future while the image data 192 is presented. The image frame statistics 194 may include data line statistics, which may be obtained based on time domain waveforms transmitting on specific data lines. The image frame statistics 194 may include pixel emission current statistics. The image frame statistics 194 may include an indication of a tile average pixel current equivalent (TAPCE), which may be used by the image processing system 188 to determine impedances based on current equivalent statistic indications of respective tiles. The tile may refer to a logical association of a spatial region of pixels that the image processing system 188 uses when determining the image frame statistics 194. Each tile may have its own respective image frame statistic generated for inclusion with a set of data used as the image frame statistics 194. Tiles may be symmetric or asymmetric (as may be appreciated later with respect to discussion of FIG. 14)—indeed, any suitable tile shape may be used to generate the image frame statistics 194.

The image frame statistics 194 may be transmitted to the touch processing system 190 in a packet that may or may not be encrypted. In some systems, the image frame statistics 194 are sent via a dedicated path between the touch processing system 190 and the image processing system 188, where the dedicated path may bypass one or more communication pathways between the touch processing system 190 and the image processing system 188.

The encoder 196 may compress a packet that includes the image frame statistics 194 before transmitting the image frame statistics 194 to the processing circuitry 198. Compressing the packet may involve encrypting the image frame statistics 194 in some systems. However, the packet compression may be performed without encryption in some systems. If the image processing system 188 includes an encoder 196 or similar encoding operation, the touch processing system 190 may include a decoder 208 to complement the encoding operations performed by the image processing system 188 on the packet including the image frame statistics. The touch processing system 190 may decode the packet before transmitting the image frame statistics, decoded, to the processing circuitry 198 for further processing.

The processing circuitry 198 may use the image frame statistics 194 to generate an estimated amount of impedance DTI 200. A removal operation block 202 may receive the estimated amount of impedance DTI 200 and touch scan data 204. The touch scan data 204 may include measured transmit path (Tx) common mode (CM) indication and a measured receive path (Rx) common mode (CM) indication. The removal operation block 202 may remove impedance DTI noise from the touch scan data 204 to generate compensated touch scan data 206 that may include reduced amounts of noise and therefore may have improved signal-to-noise characteristics. An example removal operation block 202 may include a subtractor. As described above, the processing circuitry 198 may generate an estimated indication of interference with the touch operation, such as data indicating an estimated amount of impedance DTI 200, and the touch processing system 190 may use that estimated indication to improve actual touch scan data so that the touch processing system 190 may improve sensing analysis and determination operations performed to interpret and process the touch scan data. In some systems, the estimated indication of interference (e.g., amount of impedance DTI 200) may be used to seed further processing operations. This generally may enable the touch processing system 190 to determine which portion of the touch scan data is attributed to the actual tactile input and what portion of the touch scan data is illusory from noise.

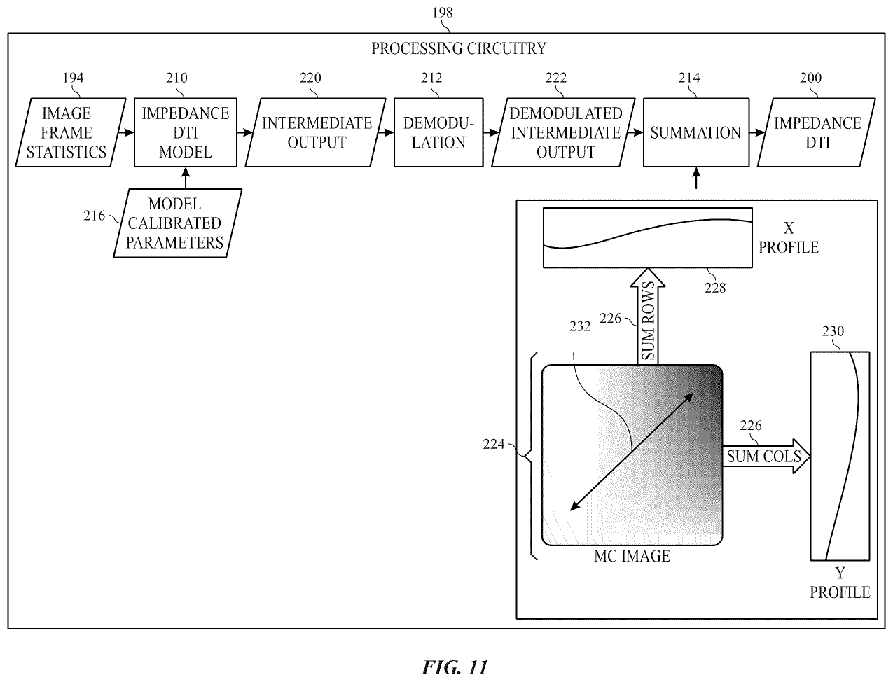

To describe the processing circuitry 198 operations further, FIG. 11 is a diagrammatic representation of operations of the processing circuitry 198 of FIG. 10. Although certain operations are described herein, it should be understood that additional or alternative operations may be performed by the processing circuitry 198 and/or the touch processing system 190 when generating the estimated impedance DTI 200.

The processing circuitry 198 may receive decoded image frame statistics 194 received from the image processing system 188. The processing circuitry 198 may be programmed to process the image frame statistics 194 based on an impedance DTI model 210, a digital signal processing (DSP) operation 212, and/or a summation 214 of row data and/or column data on the output from the DSP operation 212. The DSP operation 212 may involve the processing circuitry 198 performing a phase rotation, a demodulation, a digital scaling operation, or other suitable digital signal processing operation.

The impedance DTI model 210 may use one or more partial differential equations to model performance of the electronic display 12 to predict impedance DTI. The impedance DTI model 210 may be based on a set of model calibrated parameters 216 that correspond one or more impedances of a panel of the electronic display 12. The panel may vary in impedances from another panel (e.g., a different manufactured electronic devices 10) due to material differences. The model calibrated parameters 216 may be partially or fully pre-computed during manufacturing or calibration of the electronic device 10 before shipment to a user. The model calibrated parameters 216 may include image-independent data.

The model calibrated parameters 216 may include a first parameter (p₀) corresponding to a sheet resistance of the cathode layer 136, which may be represented by a complex number. The sheet resistance may impact an amount of current flowing through the cathode layer 136 to ground. The first parameter may correspond to impedance DTI in that the less resistance indicated by the first parameter, the smoother the impact of impedance DTI is to the noise introduced into the touch scan data.

The model calibrated parameters 216 may include a second parameter (p₁) corresponding to a parasitic effect determined while the pixels 54 were operated to present baseline image data. The baseline image data may correspond to black image data (e.g., 0, 0, 0). Some systems may use other image data as the baseline image data, such as all while image data (e.g., 255, 255, 255), or any other suitable color (e.g., red, yellow, blue, any suitable color) or pattern (e.g., black and white checkered image content). A complex number may represent the second parameter.

The model calibrated parameters 216 may include a third parameter (p₂) corresponding to a parasitic effect determined while the pixels 54 were operated to switch from presenting a first image data to presenting a second image data. The first image data may correspond to black image data and the second image data may correspond to white image data. Some systems may use other image data as the first image data and/or the second image data, such as any other suitable color (e.g., red, yellow, blue, any suitable color) or pattern (e.g., black and white checkered image content). A complex number may represent the third parameter. The third parameter may indicate a parasitic effect introduced from changing image content over time and thus may correspond to a temporal noise introduced as part of impedance DTI.

The model calibrated parameters 216 may include a set of one or more parameters (C_{R}, C_{G}, C_{B}) corresponding to color channel TAPCE scalars that may be sent to the image processing system 188 portion of the SOC 184. Each light-emitting component of the display pixels 54 may have its own material channel that has different current-voltage characteristic curves from the other material channels of the other light-emitting components. Complex numbers may represent this set of parameters. Each parameter of the set of parameters (C_{R}, C_{G}, C_{B}) may indicate a respective contribution to impedance DTI based on material properties of respective color channel circuitry and/or color channel-specific routing or processing networks. One or more of the respective material channels may be represented in a respective parameter. For example, the parameter C_{R} may represent material channel characteristics in its scalar value based on material channels used to transmit red data to one or more of the display pixels 54. Any suitable granularity of sets of display pixels 54 may be represented through a respective parameter. In some cases, the set of parameters may be determined based on pixel associations of respective tiles, and thus a respective set of parameters may be determined to indicate material properties corresponding to respective tile associations of display pixels 54.

The model calibrated parameters 216 may include one or more fourth parameters corresponding to boundary conditions of the electronic display 12. The boundary conditions may limit the impedance DTI model 210 applied by the processing circuitry 198 to the physical size and arrangement of the electronic display 12 as opposed to one of infinite or much larger size. The fourth parameter may be represented by a complex number and define relative grounding or floating scalars for each physical edge of the electronic display 12. For example, a respective scalar may be used to represent each of four physical edges of a panel of the electronic display 12.

The processing circuitry 198 may receive the model calibrated parameters 216 before receiving the image frame statistics 194. The image frame statistics 194 may be image-dependent and change (e.g., be resent by the image processing system 188) when image content to be presented on the electronic display 12 changes. The image frame statistics 194 may change in response to tactile input received via the electronic display 12. The model calibrated parameters 216 may be set during manufacturing or calibration before the electronic device 10 is operated by a user. Accordingly, the model calibrated parameters 216 and/or the impedance DTI model 210 may be stored in memory 20 until the processing circuitry 198 is instructed to read the model calibrated parameters 216 and/or the impedance DTI model 210 from the memory 20.

Once the processing circuitry 198 receives the image frame statistics 194, the processing circuitry 198 may apply the impedance DTI model 210 incorporating the electronic device-specific model calibrated parameters 216 to the image frame statistics 194 to produce an intermediate output 220 indicative of an estimated impedance DTI.

The processing circuitry 198 may perform a DSP operation on the intermediate output 220. The DSP operation may involve the processing circuitry 198 performing a demodulation, a phase rotation, a digital scaling operation, or other suitable digital signal processing operation. In some cases, the demodulation may be selective, such as a 9:2 demodulation. However, any suitable demodulation may be used.

The demodulated intermediate output 222 may be processed by the processing circuitry 198 based on one or more X-axis profiles 228, one or more Y-axis profiles 230, or both to generate the indication of an amount of impedance DTI 200. The touch processing system 190 may, via the processing circuitry 198, use the image frame statistics 194 to determine the indication of the amount of impedance DTI 200. The indication of the amount of impedance DTI 200 may correspond to an estimated amount of impedance DTI, may correspond to data that may be used to directly cancel an effect of impedance DTI, or may correspond to data that may be fed into an algorithm to compensate for (e.g., remove via removal operation 202) the undesired impedance DTI component of touch scan data 204 (e.g., obtained based on touch sensing signals). The estimated amount of impedance DTI 200 may be used by the touch processing system 190 to generate the output touch scan data having been compensated of Impendence DTI.

To do so, the processing circuitry 198 may generate one or more X-axis profiles 228, one or more Y-axis profiles 230, or both based on a mutual capacitance (MC) image 224. The processing circuitry 198 may receive a mutual capacitance (MC) image 224 and may sum (e.g., sum operations 226) respective data of the MC image 224 to generate the estimated amount of impedance DTI 200. The MC image 224 may include one or more X-axis profiles 228 and one or more Y-axis profiles 230. The processing circuitry 198 may generate an X-axis profile 228 from the MC image 224 based on summing rows of the MC image 224 and may generate a Y-axis profile 230 from the MC image 224 based on summing columns of the MC image 224. After generating the X-axis profile 228 and the Y-axis profile 230, the processing circuitry 198 may generate the estimated amount of impedance DTI 200 based on the X-axis profile 228 and the Y-axis profile 230.

The MC image 224 may indicate a mutual capacitance between one or more respective touch sense regions 56 and how a tactile input may change the mutual capacitance. Since the MC image 224 may indicate the mutual capacitance, the MC image 224 maps a source of noise of impedance DTI. In this example, noise is illustrated in the MC image 224 as a gradient 232 radiating out from a top-right corner of the depiction of the MC image 224. It should be understood that this is one example of a source of noise captured by one example MC image 224 and that other mappings of sources of noise may be used herein.

A localization scan may be used to generate the MC image 224. For example, a localization scan may involve one or more scans and sometimes include operations like skipping a scan if no tactile input is detected by the touch processing system 190.

In some cases, the MC image 224 may be generated based on a scan using touch equivalent modelling as opposed to a localization scan (which may use relatively higher amounts of power). By generating the MC image 224 based on a scan using touch equivalent modelling, less power may be consumed when estimating an amount of impedance DTI.

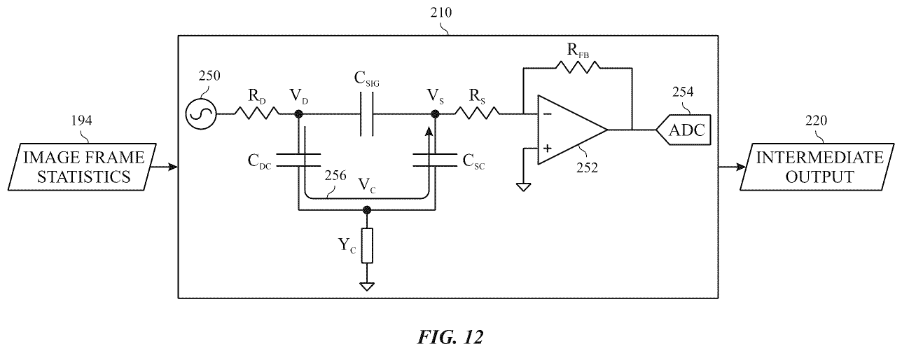

An example impedance DTI model 210 is elaborated on relative to FIG. 12. FIG. 12 is a diagrammatic representation of an example portion of the impedance DTI model 210 of FIG. 11, which may be used to determine an expected cathode voltage. It should be understood that this is one example of an impedance DTI model 210 and that other suitable examples may be used in conjunction with systems and methods described herein. Furthermore, the example impedance DTI model 210 of FIG. 12 is illustrated with circuitry and it should be understood that in some systems the electrical characteristics of the circuitry may be modelled through one or more equations applied by the processing circuitry 198 of the touch processing system 190 to generate the estimated amount of impedance DTI 200 output.

For example, the one or more equations may be generated using fitting operations to selected fitted parameters to be applied to the one or more equations to suitably model the cathode layer 136, the parasitics associated with the cathode layer 136, and how the parasitics affect current spreading relative to the cathode layer 136, such as how localized the current draining is versus whether the draining is expected to relatively spread out. The impedance DTI model 210 may use a resistor-capacitor (RC) network to predict a response of the cathode layer 136 to the parasitics and the current spreading. Voltages of the RC network may be based on one or more sensed anode voltages, one or more sensed data line voltages, and/or one or more sensed pixel emission currents of one or more display pixels 54. Anode voltage sensing may be used in lieu of data line voltage sensing or pixel emission currents. Data line voltage sensing may be used in lieu of anode voltage sensing or pixel emission currents. Pixel emission current sensing may be used in lieu of anode voltage sensing or data line voltage sensing. These parameters to be sensed may be based on image content and thus may be considered image data-dependent. An example of the RC network is illustrated in FIG. 13. Other suitable RC networks may be used.

Referring briefly to FIG. 13, FIG. 13 is a diagrammatic representation of a cathode RC network associated with FIG. 12 to determine the expected cathode voltage of FIG. 12. Applying image content-dependent data (e.g., image frame statistics 194) and the model calibrated parameters 216 to the RC network of FIG. 13 may enable the processing circuitry 198 to determine some parameters to be applied to the portion of the impedance DTI model illustrated in FIG. 12. For ease of description, FIGS. 12 and 13 are described together here to further elaboration on the RC network of FIG. 13 and its relationship to the impedance DTI model of FIG. 12 in this example described herein.

Referring now to FIGS. 12 and 13 together, the illustrated portion of the impedance DTI model 210 may correspond to a mutual capacitance based model that may better model relatively larger electronic devices 10, like phones and/or larger electronic display 12 panels, relative to models used for smaller electronic devices 10, like watches. The mutual capacitance-based model may use fewer computing resources to estimate impedance DTI relative to other systems and methods.

Voltage source 250 may supply a test voltage to enable estimation of the impedance DTI. The voltage source 250 may generate a sine wave stimulus, a square wave stimulus, other suitable single tone signal or other suitable multi-tone stimulus signal. Voltage source 250 may be coupled to a drive resistance (R_{D}) coupled to a drive cathode capacitance (C_{DC}) and a signal capacitance (C_{SIG}) through a node that corresponds to a drive voltage (V_{D}). The signal capacitance (C_{SIG}) may couple to a source cathode capacitance (C_{SC}) and a source resistance (R_{S}) through a node that corresponds to a sense voltage (V_{S}). The source cathode capacitance (C_{SC}) may couple to the drive cathode capacitance (C_{DC}) and to a cathode admittance (Y_{C}), which is coupled to ground, through a node that corresponds to a cathode voltage (V_{C}). The source resistance (R_{S}) may be coupled to a negative input of an operational amplifier 252, which has a positive input coupled to ground. A node between the source resistance (R_{S}) and the negative input of the operational amplifier 252 may couple to an output from the operational amplifier 252 as part of a feedback path that includes a feedback resistance (R_{FB}). An analog to digital converter 254 may sense the output from the operational amplifier 252 and convert the output from an analog voltage into a digital value indicative of the analog voltage value.

The cathode layer 136 may be the dominant layer for impedance DTI. The dominant current for impedance DTI may transmit through path 256. The dominant current for impedance DTI may transmit from the drive voltage (V_{D}) node, to the drive cathode capacitance (C_{DC}), to the source cathode capacitance (C_{SC}) via the cathode voltage (V_{C}) node, and to the source resistance (R_{S}) node. The RC network 260 of FIG. 13 may show relative use of some of these parameters to determine the values applied to the impedance DTI model 210. The RC network 260 may be based on repeated boundary unit cells 262 and repeated interior unit cells 264. A respective cell (e.g., interior unit cells 264, boundary unit cells 262) may be associated spatially to a tile.

Furthermore, the impedance DTI model 210 may compensate for boundary conditions (e.g., at the edge of a panel being mapped to an edge of the RC network 260) by including a boundary resistance (RB) into the determinations of boundary unit cells 262 of the RC network 260. The respective cells of the RC network 260 may also model a cathode resistance (R_{C}), which may contribute to the cathode voltage (V_{C}) along with the cathode admittance (Y_{C}). It may be presumed may be that the cathode resistance is spatially uniform across a R_{C} network 260, and presuming as such may reduce an amount of computing resources consumed to determine the cathode voltage (V_{C}). The cathode resistance (R_{C}) may not be image content dependent and thus may be one of the parameters determined during manufacturing and/or calibration with other of the model calibrated parameters 216. In some systems, cathode resistance (R_{C}) may correspond to the first parameter (p₀) of a cathode sheet resistance.

Thus, the impedance DTI model 210 may determine the changes in cathode voltage (V_{C}) to determine an estimated amount of impedance DTI 200 given the respective image frame statistics 194. Indeed, the impedance DTI experienced by the touch receive path (Touch RX) may be linearly related to the cathode voltage (V_{C}).

It is noted that the impedance DTI model 210 may be determined based on a presumption that TAPCE statistics provided as part of the image frame statistics 194 are linear with respect to the cathode admittance (Y_{C}) and ground. In some cases, the impedance DTI model 210 may be determined based on non-linear relationship presumptions. For example, the impedance DTI model 210 may be determined based on a presumption that TAPCE statistics provided as part of the image frame statistics 194 are non-linear with respect to the cathode admittance (Y_{C}) and ground. Another presumption may be that the touch system performances are measured at an AC steady state condition, once settling voltages have indeed propagated for a suitable amount of time as to settle.

It is noted that the impedance DTI model 210 may include additional or alternative components relative to those components illustrated in FIGS. 11 and 12. For example, the circuitry illustrated in FIG. 12 may be used to determine the cathode voltage and additional circuitry may be included or modelled by the impedance DTI model 210 to provide for a cathode smoothing effect determination and its effect on drive voltage of the cathode layer 136 relative to the image content expected to be presented based on the image frame statistics 194. The processing circuitry 198 may determine the cathode smoothing effect as part of the impedance DTI model 210 before receiving the image frame statistics 194 when the cathode smoothing effect is determined based on the model calibrated parameters 216 and a matrix of second derivatives associated with the cathode layer 136.

The additional circuitry corresponding to the impedance DTI model 210 may enable the touch processing system 190 to determine an effect on cathode voltage relative to multiple tiles. Therefore, parameters and operations applied by the processing circuitry 198 to apply the impedance DTI model 210 may involve matrices and dataset handling to determine the cathode voltage relative to tiles of touch pixel and display pixel associations. Each tile may be a respective touch pixel. It is noted that any suitable grouping of display pixels may be associated with any suitable grouping of touch pixels as part of a tile. Based on one or more tiles, the processing circuitry 198 may determine the cathode voltage based on solving a set of linear system of equations used to model the cathode layer 136 by the impedance DTI model 210.

Indeed, the impedance DTI model 210 may include a relationship between the cathode voltage discretized to tiles as a linear system of equations, which may depend on a TAPCE image determined by the image processing system 188. The TAPCE image may correspond to the image frame statistics 194. For example, the image frame statistics 194 may include TAPCE image data generated based on the image data 192. A cathode voltage contribution may be generated for each tile, which may correspond to a tile size parameter. The tile size parameter may be read from memory 20 and applied by the touch processing system 190, such that the processing circuitry 198 may apply a desired tile size to the processing operations performed to generate the estimated amount of impedance DTI 200.

The set of linear system of equations may be based on the model calibrated parameters 216 and several parameters, which may include one or more touch pixel location parameters, the drive voltage (V_{D}), a frequency based on a stimulation frequency (e.g., 2π times the stimulation frequency, π times the stimulation frequency), the sheet resistance of the cathode layer 136 (R_{C}), a drive-to-cathode capacitance (C_{DC}), a cathode conductance to ground based on black image data, cathode conductance change from the black image data to white image data, cathode capacitance to ground (C_{CG}), or the like. The set of linear system of equations may be based on the repeated unit cell architecture of the R_{C} network 260. In some systems, four repeated unit cells may be used to generate the set of linear system of equations, where the touch pixel location parameters may correspond to a number of cells used to generate the set of linear system of equations.

Certain processing operations and relationships are described herein. It should be understood that the systems and methods described herein may be applied to any suitable impedance DTI model 210.

As described herein, the processing circuitry 198 may generate the estimated amount of impedance DTI 200 based on tiles, which may be defined through a tile size parameter. Although the tiles may be symmetrical and uniform, in some systems, tiles may be asymmetrical and/or non-uniform.

Indeed, FIG. 14 is a diagrammatic representation of an example of asymmetric tiles. The processing circuitry 198 may use one or more spatial stencils 270 when processing tiles. Spatial stencils 270 may associate one or more display pixels 54 to one or more touch sense regions 56, which may already be associated through one or more tile. This may enable the processing circuitry 198 to determine the estimated amount of impedance DTI 200 based on one or more non-rectangular interleaved tiles, which may be asymmetrical. In FIG. 14, display image data 272 may correspond to image content of alternating, high contrast images to be presented via one or more display pixels 54. An example association between four touch sense regions 56 (touch sense regions 56A, touch sense regions 56B, touch sense regions 56C, touch sense regions 56D) and the high contrast image content being presented is illustrated via inset diagram 276. Each touch sense regions 56 may be associated with one or more display pixels 54

A spatial stencil 270 may involve including a portion of nearby adjacent display pixels 54 as part of a logical association of contiguous display pixels 54 (e.g., tile), which may have at first excluded the portion that is now included. More than one portion may be included in a tile even if the more than one portions were excluded from the tile per the tile size parameter. Indeed, touch sense region 56D may correspond to an ideal, symmetrical, square tile. Touch sense region 56D may be processed as a tile or as part of a tile (e.g., depending on granularity of processing selected via the tile size parameter) without one of the spatial stencils 270. Touch sense regions 56A, 56B, and 56C may be processed as a tile or as part of a tile with one of the spatial stencils 270. Touch sense region 56A may correspond to spatial stencil 270A. The processing circuitry 198 may apply the spatial stencil 270A to the tile of touch sense region 56A to include a portion 278 of display pixels 54 from touch sense region 56B in the determinations of touch sense region 56A. The portion 278 of display pixels 54 may be disposed physically in a footprint otherwise assigned to a tile of the touch sense region 56B and may be processed computationally with the tile of touch sense region 56A to determine the estimated amount of impedance DTI. Similarly, the processing circuitry 198 may apply a spatial stencil 270B to exclude the portion 278 of display pixels 54 from processing in the tile of the touch sense region 56B while including a portion 280 of display pixels 54 in the tile of the touch sense region 56B. Moreover, the processing circuitry 198 may apply a spatial stencil 270C to include portions 282 of display pixels 54 from processing in the tile of the touch sense region 56A while including the portions 282 if the display pixels 54 in the processing of the tile of the touch sense region 56C.

In some systems, different spatial stencils may be used for each of interior touch sense regions 56, corner touch sense regions 56, top physical edge or boundary of touch sense regions 56, bottom physical edge or boundary of touch sense regions 56, and/or special display pixels 54, which may not fit as well into a tile association as other display pixels 54 of a same panel due to a brightness characteristic, a certain amount of impedance DTI associated to that special display pixel 54 relative to a threshold or an average performance of nearby display pixels 54 (e.g., other display pixels 54 within a threshold distance from the special display pixel 54 or otherwise associated logically to a same tile through a tile size parameter), or the like. Spatial stencils may be configurable during calibration to be fit to physical characteristics of the panel of the electronic display 12. Spatial stencils 270 may improve centroiding for tactile input analysis. To apply the spatial stencils 270, the processing circuitry 198 may apply a mask within a tile to which display pixels 54 would be associated with the touch receive path (Touch RX) in that physical location on the panel. The mask on the tile may be used during calibration or manufacturing to precompile the model calibrated parameters. The mask on the tile may be used by the processing circuitry 198 to apply the image frame statistics 194 to the impedance DTI model 210. In some systems, the touch processing system 190, via the processing circuitry 198, may determine that a capacitive object making tactile input with the electronic display 12 is a certain type of object (e.g., first object type) and, based on such determination, the touch processing system 190 may determine the estimated amount of impedance DTI 200 based on one or more image frame statistics 194, one or more model calibrated parameters 216, the impedance DTI model 210 (e.g., the model of impedance display-touch interference characteristics of the electronic display), and one or more spatial stencils corresponding to that type of object. The spatial stencils may be designed as far as inclusions and exclusions of certain pixels past on performance on the electronic display 12 during calibration and manufacturing.

It is noted that systems and methods described herein may aid in determining a quantification of an impact of the programmed display pixel 54 on touch pixels (e.g., touch sense regions 56) through estimating impedance DTI based on model calibrated parameters 216 and image content dependent data (e.g., image frame statistics 194) and in compensating for that quantified impact. Thus, although certain structures and circuitries are described herein, it should be understood that many different type of electronic devices, display pixels, and touch pixels may benefit from using systems and methods described herein. Indeed, a wide variety of electronic display and tactile input devices may benefit from these operations described herein since these compensation operations may be deployed across a wide range of devices including phones, tablets, watches, desktops, and even other displays with integrated touch and display panels. Moreover, touch performance of the display panel may be quantified by comparing performance while the operations are performed vs. while the operations are not performed. This may enable selective use of the crosstalk compensation operations and further power reductions by compensating for the crosstalk when most appropriate. For example, crosstalk compensation operations may be performed in response to particularly noisy data expected or scheduled to be displayed, in response to periodic timelines or schedules, in response to an input via an input device, or other suitable inputs or signals to trigger performance of the crosstalk compensations.

Technical effects include using the described systems and methods to improve touch performance in integrated image and touch display when unwanted parasitic coupling is present in the circuitry between three conducting layers, as may occur in display panels driving a single tone stimulus or a multi-tone stimulus for a mutually capacitive system. A single tone stimulus may be driven with one or more sine waves (e.g., discrete stimulus). A multi-tone stimulus may be driven with one or more square waves (e.g., a wideband multi-tone stimulus). These error determination and cancellation systems and methods may be broadly applied to other systems as well, which may include a range of devices like phones, tablets, watches, desktop computers, laptop computers, or the like. By reducing the error contributions from impedance DTI based on image data to be presented via the display, and thus electrical signals expected to be created by pixels that interfere with touch sensing operations, the accuracy and reliability of touch sense data may improve. Furthermore, in considering spatial stencils, by expanding a shape and size of the tile through which the determination may be made, the processing circuitry may be able to perform computational aggregations or determinations for a wider range of touch sensor designs with increased accuracy of predict since performance may be better fit over non-rectangular, asymmetrical spatial stencils to process underlying tiles.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

Furthermore, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ,” it is intended that such elements are to be interpreted under 35 U.S.C. 112 (f). However, for any claims containing elements designated in any other manner, it is intended that such elements are not to be interpreted under 35 U.S.C. 112 (1).

What is claimed is:

1. A system comprising:
an electronic display configured to present image data during a touch sensing operation configured to generate touch scan data; and
a touch processing system configured to:
estimate a display-to-touch interference in the touch scan data based on:
one or more image-dependent parameters configured to change based on the image data;
a plurality of summation operations associated with respective portions of the electronic display; and
one or more image-independent parameters; and
adjust the touch scan data based on the estimated display-to-touch interference.

2. The system of claim 1, comprising an image processing system configured to generate the one or more image-dependent parameters based on sensing one or more currents of one or more display pixels.

3. The system of claim 1, wherein the one or more image-dependent parameters comprise pixel current emission statistic.

4. The system of claim 2, wherein the image-dependent parameters comprise pixel current equivalent data averaged over a plurality of tiles, wherein each tile of the plurality of tiles is configured to associate respective sets of display pixels of the electronic display with respective touch sense regions of the electronic display.

5. The system of claim 1, wherein the touch processing system is configured to estimate the display-to-touch interference based on applying an impedance display-to-touch interference model to generate an intermediate output.

6. The system of claim 5, wherein the touch processing system is configured to estimate the display-to-touch interference based on performing one or more digital signal processing operations on the intermediate output.

7. The system of claim 1, wherein the one or more image-independent parameters comprises:
a resistance of a cathode layer of the electronic display;
one or more parasitic effect parameters;
one or more color channel parameters;
one or more boundary condition parameters; or
any combination thereof.

8. The system of claim 1, wherein the touch processing system is configured to identify a proximity of a tactile input relative to a touch sense region of the electronic display based on the adjusted touch scan data.

9. The system of claim 1, wherein the touch processing system is configured to adjust the touch scan data at least in part by providing the estimated display-to-touch interference to a seed of a separation operation to identify an amount of noise to remove from the touch scan data.

10. A non-transitory, tangible, computer-readable medium comprising instructions that, when executed by a processor, are configured to cause a touch processing system to perform operations comprising:
receiving image frame data from an image processing system, wherein the image frame data corresponds to an image frame to be presented on an electronic display during a touch sensing operation configured to generate touch scan data;
estimating a display-to-touch interference in the touch scan data generated based on one or more image-dependent parameters configured to change based on the image frame, a plurality of summations associated with respective portions of the electronic display, and one or more image-independent parameters; and
adjusting the touch scan data based on the estimated display-to-touch interference.

11. The computer-readable medium of claim 10, wherein the operations comprise identifying a proximity of a tactile input relative to a touch sense region of the electronic display determined from the adjusted touch scan data.

12. The computer-readable medium of claim 11, wherein estimating the display-to-touch interference changes based on one or more spatial stencils associated with a type of the tactile input.

13. The computer-readable medium of claim 10, wherein the operations comprise receiving the one or more image-independent parameters comprising:
a resistance of a cathode layer of the electronic display;
one or more parasitic effect parameters;
one or more color channel parameters;
one or more boundary condition parameters; or
any combination thereof.

14. The computer-readable medium of claim 10, wherein the operations comprise receiving the one or more image-dependent parameters comprising:
one or more sensed anode voltages of one or more display pixels;
one or more pixel emission currents associated with one or more display pixels configured to present the image frame;
data line statistics data;
pixel current equivalent data averaged over a plurality of tiles, wherein each tile of the plurality of tiles associates one or more display pixels with a touch sense region; or
any combination thereof.

15. A non-transitory, tangible, computer-readable medium comprising instructions that, when executed by a processor, are configured to cause an image processing system to perform operations comprising:
receiving image data to be presented on an electronic display during a touch sensing operation;
generating image-dependent data based on the image data; and
sending the image-dependent data to a touch processing system configured to predict, based on the image-dependent data, an estimated impedance display-touch interference expected during the touch sensing operation before the touch sensing operation is performed.

16. The computer-readable medium of claim 15, wherein determining the image-dependent data comprises averaging pixel current data over a plurality of tiles configured to respectively associate one or more display pixels with respective touch sense regions.

17. The computer-readable medium of claim 15, wherein the operations comprise encoding the image-dependent data before sending the image-dependent data to the touch processing system.

18. The computer-readable medium of claim 17, wherein the operations comprise encrypting the encoded image-dependent data before sending the encoded image-dependent data to the touch processing system.

19. The computer-readable medium of claim 15, wherein generating the image-dependent data comprises:
receiving a tile size parameter indicating a logical size;
receiving one or more spatial stencils based on a type of object sensed during the touch sensing operation; and
processing the image data based on the tile size parameter and the one or more spatial stencils.

20. The computer-readable medium of claim 19, wherein processing the image data comprises averaging a subset of the image data over a plurality of tiles based on applying the one or more spatial stencils to mask the image data.
